(19) United States
(12) Patent Application Publication
(10) Pub. No.: US 2008/0224935 A1
(43) Pub. Date: Sep. 18, 2008

(54) ANTENNA

(75) Inventor: Noboru KATO, Moriyama-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: MURATA MANUFACTURING CO., LTD., Nagaokakyo-shi (JP)

(21) Appl. No.: 11/688,290

(22) Filed: Mar. 20, 2007

Related U.S. Application Data
(60) Provisional application No. 60/745,884, filed on Apr. 28, 2006.

(30) Foreign Application Priority Data
Apr. 14, 2006 (JP) 2006-112352
Sep. 20, 2006 (JP) 2006-254153
Nov. 17, 2006 (JP) 2006-311546

(51) Int. Cl. H01Q 9/00; H01Q 1/50

(52) U.S. Cl. 343/749; 343/860

(57) ABSTRACT

An antenna includes inductance elements that are magnetically coupled together, an LC series resonant circuit that includes one of the inductance elements and capacitance elements, and an LC series resonant circuit that includes another of the inductance elements and capacitance elements. The plurality of LC series resonant circuits are used to radiate radio waves and are used as inductances of a matching circuit that matches an impedance when a power supply side is viewed from power supply terminals and a radiation impedance of free space.

### BACKGROUND OF THE INVENTION

1. Field of the Invention

The present invention relates to antennas, and in particular, to a small surface-mountable broadband antenna.

2. Description of the Related Art

A helical antenna is disclosed in Japanese Unexamined Patent Application Publication No. 2003-37426 (Patent Document 1) as a small antenna that is used in mobile communication, such as cellular phones. The helical antenna enables operation in two frequency bands by winding an excitation coil around a long and narrow insulating main body in a helical fashion and winding first and second non-feeding coils around the main body in a helical fashion so that the first and second non-feeding coils are located adjacent to the excitation coil.

However, the spacing between the two frequency bands, in which the helical antenna can operate, is equal to or greater than several hundreds of megahertz, and the two frequency bands cannot be set close to each other so that the spacing is equal to or less than about 100 MHz. Moreover, although the band width of each frequency band is broad as compared to that of a helical antenna including a single coil, a sufficiently broad band width cannot be achieved.

### SUMMARY OF THE INVENTION

To overcome the problems described above, preferred embodiments of the present invention provide a small antenna in which a broad band is achieved.

An antenna according to a first preferred embodiment of the present invention includes power supply terminals and at least two inductance elements that have different inductance values, wherein the inductance elements are used to radiate radio waves and are used as inductances of a matching circuit that matches an impedance when a power supply side is viewed from the power supply terminals and a radiation impedance of free space.

The at least two inductance elements, which have different inductance values, are preferably used as inductances of a matching circuit, such that the impedance of devices connected to the power supply terminals and the impedance (approximately 377 Ω) of space can be matched in a substantially broad band. Thus, a small broadband antenna is obtained, and the antenna can be surface mountable.

An antenna according to a second preferred embodiment of the present invention includes power supply terminals and a plurality of resonant circuits, wherein the plurality of resonant circuits are used to radiate radio waves and are used as inductances of a matching circuit that matches an impedance when a power supply side is viewed from the power supply terminals and a radiation impedance of free space.

Inductance components of the plurality of resonant circuits, which are used to radiate radio waves, are used as inductances of a matching circuit, such that the impedance of devices connected to the power supply terminals and the impedance (approximately 377Ω) of space can be matched in a substantially broad band. Thus, a small broadband antenna is obtained, and the antenna can be surface mountable.

The plurality of resonant circuits may include capacitance elements and inductance elements. In this case, it is preferable that the plurality of resonant circuits be electrically directly connected to the power supply terminals or via a lumped constant capacitance or inductance. Moreover, it is preferable that a coupling coefficient between adjacent resonant circuits out of the plurality of resonant circuits be of at least about 0.1.

Moreover, the inductance elements included in the plurality of resonant circuits may be defined by a line electrode pattern in which the inductance elements are disposed in the direction of one axis. It is preferable that the capacitance elements be electrically connected to the power supply terminals for surge protection. When the capacitance elements are provided in a laminated substrate, reduction in the size is not inhibited. When the plurality of resonant circuits is provided in a laminated substrate, a reduction in the size is further facilitated, and the manufacturing is also facilitated by a lamination method.

An antenna according to a third preferred embodiment of the present invention includes first and second power supply terminals and a plurality of resonant circuits. The antenna includes a first LC series resonant circuit that includes a first inductance element and first and second capacitance elements that are electrically connected to both ends of the first inductance element, and a second LC series resonant circuit that includes a second inductance element and third and fourth capacitance elements that are electrically connected to both ends of the second inductance element, wherein the first and second inductance elements are magnetically coupled together, one end of the first inductance element is electrically connected to the first power supply terminal via the first capacitance element, and the other end is electrically connected to the second power supply terminal via the second capacitance element, and one end of the second inductance element is electrically connected to the first power supply terminal via the third and first capacitance elements, and the other end is electrically connected to the second power supply terminal via the fourth and second capacitance elements.

In the antenna according to the third preferred embodiment, the first and second LC series resonant circuits are used to radiate radio waves, and the first and second inductance elements function as inductances of a matching circuit, such that the impedance of devices connected to the first and second power supply terminals and the impedance (approximately 377Ω) of space can be matched in a substantially broad band. Moreover, the individual elements can be readily constructed in a laminate. Thus, a small surface-mountable broadband antenna is obtained.

According to preferred embodiments of the present invention, the impedance of devices connected to power supply terminals and the impedance (approximately 377Ω) of space can be matched in a substantially broad band using a plurality of inductance elements or a plurality of resonant circuits, which are used to radiate radio waves, and a small broadband antenna is obtained without providing a matching circuit separately.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an equivalent circuit diagram of an antenna according to a first preferred embodiment of the present invention.

FIG. 2 is a plan view showing a laminated structure of the antenna according to the first preferred embodiment of the present invention.

FIG. 3 is a graph showing reflection characteristics of the antenna according to the first preferred embodiment of the present invention.

FIG. 4 is a graph showing reflection characteristics of the antenna according to the first preferred embodiment of the present invention.

FIG. 5 is a chart of the X-Y plane showing directivities of the antenna according to the first preferred embodiment of the present invention.

FIG. 6 is a Smith chart showing impedances of the antenna according to the first preferred embodiment of the present invention.

FIG. 7 is an equivalent circuit diagram of an antenna according to a second preferred embodiment of the present invention.

FIG. 8 is a plan view showing a laminated structure of the antenna according to the second preferred embodiment of the present invention.

FIG. 9 is a graph showing reflection characteristics of the antenna according to the second preferred embodiment of the present invention.

FIGS. 10A to 10C show equivalent circuit diagrams of the antenna according to the second preferred embodiment of the present invention, obtained by transformation of a circuit.

FIG. 11 is an equivalent circuit diagram of an antenna according to a third preferred embodiment of the present invention.

FIG. 12 is a perspective view showing an external view of the antenna according to the third preferred embodiment of the present invention.

FIG. 13 is a graph showing reflection characteristics of the antenna according to the third preferred embodiment of the present invention.

FIG. 14 is an equivalent circuit diagram of an antenna according to a fourth preferred embodiment of the present invention.

FIG. 15 is a plan view showing a laminated structure of the antenna according to the fourth preferred embodiment of the present invention.

FIG. 16 is a graph showing reflection characteristics of the antenna according to the fourth preferred embodiment of the present invention.

FIG. 17 is an equivalent circuit diagram of an antenna according to a fifth preferred embodiment of the present invention.

FIG. 18 is a plan view showing a laminated structure of the antenna according to the fifth preferred embodiment of the present invention.

FIG. 19 is an equivalent circuit diagram of an antenna according to a sixth preferred embodiment of the present invention.

FIG. 20 is a plan view showing a laminated structure of the antenna according to the sixth preferred embodiment of the present invention.

FIGS. 21A to 21E show equivalent circuit diagrams of antennas according to other preferred embodiments of the present invention.

FIG. 22 is an equivalent circuit diagram of an antenna according to a seventh preferred embodiment of the present invention.

FIG. 23 is a graph showing reflection characteristics of the antenna according to the seventh preferred embodiment of the present invention.

FIG. 24 is an equivalent circuit diagram of an antenna according to an eighth preferred embodiment of the present invention.

FIG. 25 is a graph showing reflection characteristics of the antenna according to the eighth preferred embodiment of the present invention.

FIG. 26 is an equivalent circuit diagram of an antenna according to a ninth preferred embodiment of the present invention.

FIG. 27 is a graph showing reflection characteristics of the antenna according to the ninth preferred embodiment of the present invention.

FIG. 28 is an equivalent circuit diagram of an antenna according to a tenth preferred embodiment of the present invention.

FIG. 29 is a plan view showing a laminated structure of the antenna according to the tenth preferred embodiment of the present invention.

FIG. 30 is a graph showing reflection characteristics of the antenna according to the tenth preferred embodiment of the present invention.

FIG. 31 is an equivalent circuit diagram of an antenna according to an eleventh preferred embodiment of the present invention.

FIG. 32 is a graph showing reflection characteristics of the antenna according to the eleventh preferred embodiment of the present invention.

### DETAILED DESCRIPTION OF PREFERRED EMBODIMENTS

Antennas according to preferred embodiments of the present invention will now be described with reference to the drawings.

### First Preferred Embodiment

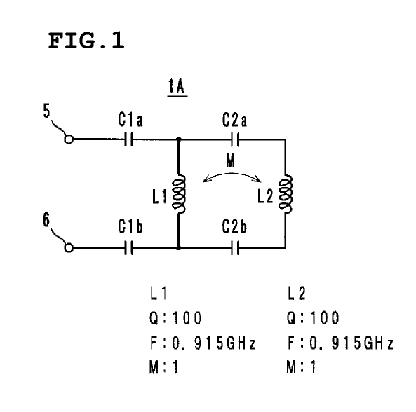

An antenna 1A according to a first preferred embodiment includes inductance elements L1 and L2 that have different inductance values and are magnetically coupled together in phase (indicated by a mutual inductance M), as shown as an equivalent circuit in FIG. 1. The inductance element L1 is connected to power supply terminals 5 and 6 via capacitance elements C1a and C1b, and is connected in parallel with the inductance element L2 via capacitance elements C2a and C2b. That is to say, this resonant circuit includes an LC series resonant circuit that includes the inductance element L1 and the capacitance elements C1a and C1b and an LC series resonant circuit that includes the inductance element L2 and the capacitance elements C2a and C2b.

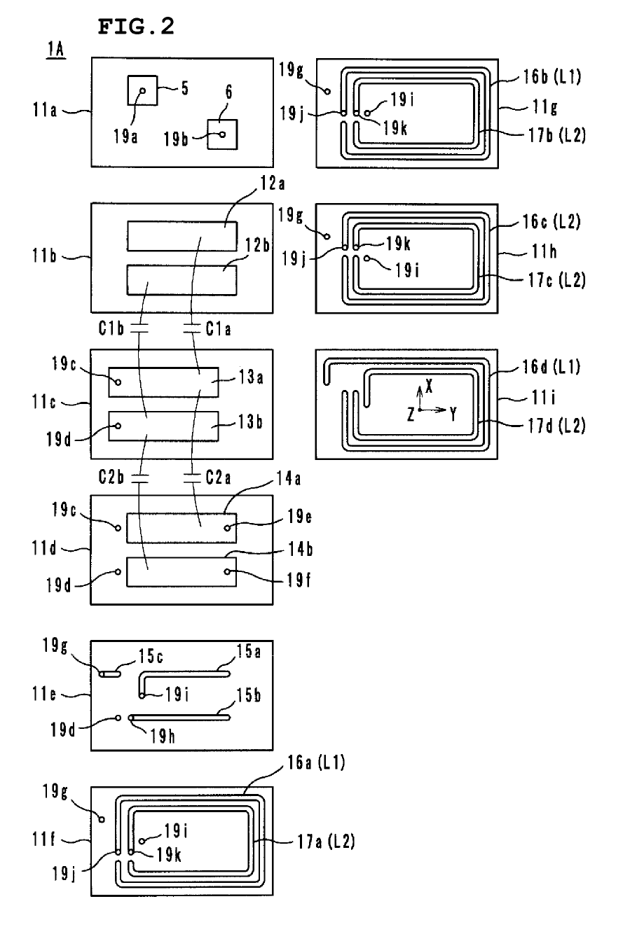

The antenna 1A having the aforementioned circuit configuration is defined by a laminate shown as an example in FIG. 2, and includes ceramic sheets 11a to 11i of dielectric material that are laminated, pressure bonded, and fired together. That is to say, the power supply terminals 5 and 6 and via-hole conductors 19a and 19b are provided in the sheet 11a, capacitor electrodes 12a and 12b are provided in the sheet 11b, capacitor electrodes 13a and 13b and via-hole conductors 19c and 19d are provided in the sheet 11c, and capacitor electrodes 14a and 14b, the via-hole conductors 19c and 19d, and via-hole conductors 19e and 19f are provided in the sheet 11d.

Moreover, connecting conductor patterns 15a, 15b, and 15c, the via-hole conductor 19d, and via-hole conductors 19g, 19h, and 19i are provided in the sheet 11e. Conductor patterns 16a and 17a, the via-hole conductors 19g and 19i, and via-hole conductors 19j and 19k are provided in the sheet 11f. Conductor patterns 16b and 17b and the via-hole conductors 19g, 19i, 19j, and 19k are provided in the sheet 11g. Conductor patterns 16c and 17c and the via-hole conductors 19g, 19i, 19j, and 19k are provided in the sheet 11h. Moreover, conductor patterns 16d and 17d are provided in the sheet 11i.

When the aforementioned sheets 11a to 11i are laminated together, the conductor patterns 16a to 16d are connected together via the via-hole conductor 19j, so that the inductance element L1 is formed, and the conductor patterns 17a to 17d are connected together via the via-hole conductor 19k, so that the inductance element L2 is formed. The capacitance element C1a is defined by the electrodes 12a and 13a, and the capacitance element C1b is defined the electrodes 12b and 13b. Moreover, the capacitance element C2a is defined by the electrodes 13a and 14a, and the capacitance element C2b is defined by the electrodes 13b and 14b.

One end of the inductance element L1 is connected to the capacitor electrode 13a via the via-hole conductor 19g, the connecting conductor pattern 15c, and the via-hole conductor 19c, and the other end is connected to the capacitor electrode 13b via the via-hole conductor 19d. One end of the inductance element L2 is connected to the capacitor electrode 14a via the via-hole conductor 19i, the connecting conductor pattern 15a, and the via-hole conductor 19e, and the other end is connected to the capacitor electrode 14b via the via-hole conductor 19h, the connecting conductor pattern 15b, and the via-hole conductor 19f.

Moreover, the power supply terminal 5 is connected to the capacitor electrode 12a via the via-hole conductor 19a, and the power supply terminal 6 is connected to the capacitor electrode 12b via the via-hole conductor 19b.

In the antenna 1A having the aforementioned structure, the LC series resonant circuits, which respectively include the inductance elements L1 and L2 magnetically coupled together, resonate, and the inductance elements L1 and L2 function as a radiating element. Moreover, the inductance elements L1 and L2 are coupled together via the capacitance elements C2a and C2b, so that the LC series resonant circuits function as a matching circuit that matches the impedance (approximately 50Ω) of devices connected to the power supply terminals 5 and 6 and the impedance (approximately 377Ω) of space.

The coupling coefficient k between the adjacent inductance elements L1 and L2 is expressed by k²=M²(L1×L2) and is preferably equal to or greater than about 0.1. In the first preferred embodiment, the coupling coefficient k is about 0.8975. The inductance values of the inductance elements L1 and L2 and the degree (the mutual inductance M) of the magnetic coupling between the inductance elements L1 and L2 are set so that a desired band width can be obtained. Moreover, since the LC resonant circuits, which include the capacitance elements C1a, C1b, C2a, and C2b and the inductance elements L1 and L2, are constructed as a lumped constant resonant circuit, the LC resonant circuits can be manufactured in a small size as a laminate, so that the LC resonant circuits are less influenced by other elements. Moreover, since the capacitance elements C1a and C1b intervene for the power supply terminals 5 and 6, a surge in low frequencies is prevented, so that the device can be protected against the surge.

Moreover, since the plurality of LC series resonant circuits include a laminated substrate, the plurality of LC series resonant circuits can be manufactured as a small antenna that can be mounted on a surface of a substrate, for example, a cellular phone and can be also used as an antenna for a radio IC device that is used in a Radio Frequency Identification (RFID) system.

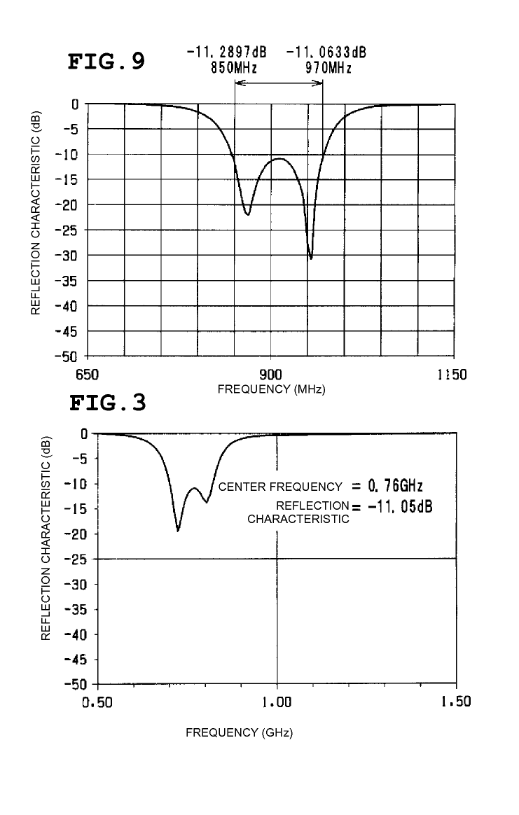

As the result of a simulation performed by the inventor using the equivalent circuit shown in FIG. 1, in the antenna 1A, the reflection characteristics shown in FIG. 3 were obtained. As shown in FIG. 3, the center frequency was about 760 MHz, and reflection characteristics of about −10 dB or less were obtained in a broad band of about 700 MHz to about 800 MHz. The reason why reflection characteristics are obtained in a broad band is described in detail in a second preferred embodiment described below.

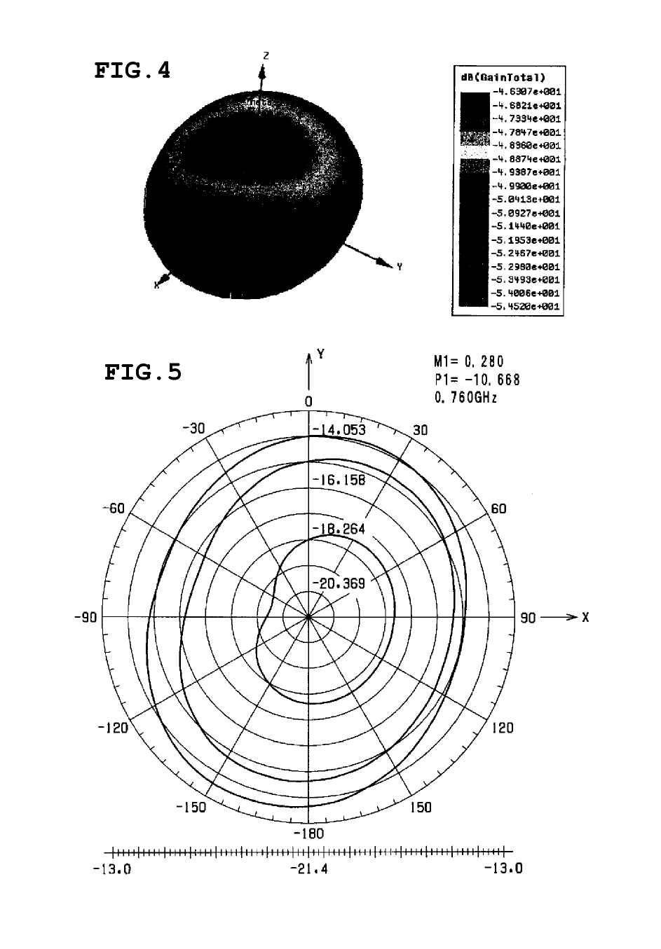

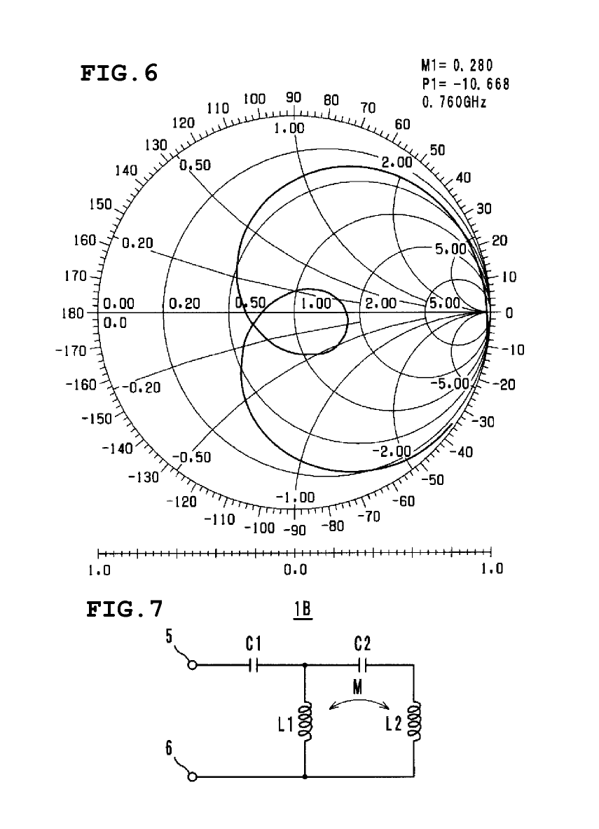

The directivity of the antenna 1A is shown in FIG. 4, and the directivity in the X-Y plane is shown in FIG. 5. The X axis, the Y axis, and the Z axis correspond to arrows X, Y, and Z shown in FIGS. 2 and 4, respectively. FIG. 6 is a Smith chart showing impedances.

### Second Preferred Embodiment

An antenna 1B according to a second preferred embodiment includes the inductance elements L1 and L2, which have different inductance values and are magnetically coupled together in phase (indicated by the mutual inductance M), as shown as an equivalent circuit in FIG. 7. One end of the inductance element L1 is connected to the power supply terminal 5 via a capacitance element C1, and is connected to the inductance element L2 via a capacitance element C2. Moreover, the other ends of the inductance elements L1 and L2 are connected directly to the power supply terminal 6. That is to say, this resonant circuit includes an LC series resonant circuit that includes the inductance element L1 and the capacitance element C1 and an LC series resonant circuit that includes the inductance element L2 and the capacitance element C2, and is substantially the same as the antenna 1A according to the first preferred embodiment, the capacitance elements C1b and C2b being omitted from the antenna 1A. The inductance values of the inductance elements L1 and L2 and the degree (the mutual inductance M) of the magnetic coupling between the inductance elements L1 and L2 are set such that a desired band width is obtained.

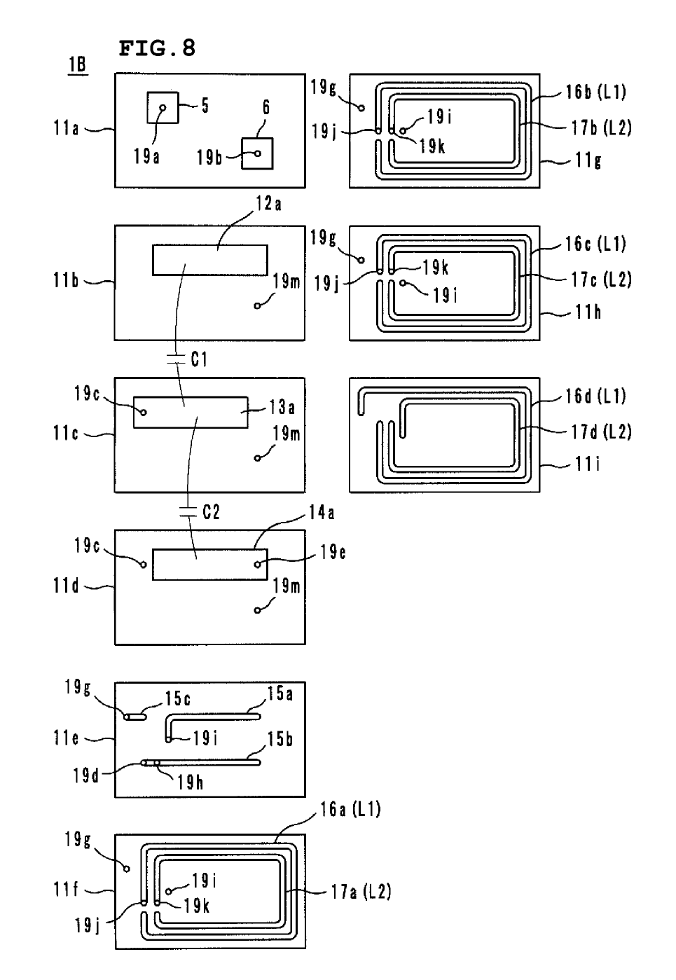

The antenna 1B having the aforementioned circuit configuration is formed as a laminate shown as an example in FIG. 8, and is composed of the ceramic sheets 11a to 11i of dielectric material that are laminated, pressure bonded, and fired together. That is to say, the power supply terminals 5 and 6 and the via-hole conductors 19a and 19b are provided in the sheet 11a, the capacitor electrode 12a and a via-hole conductor 19m are provided in the sheet 11b, the capacitor electrode 13a and the via-hole conductors 19c and 19m are provided in the sheet 11c, and the capacitor electrode 14a and the via-hole conductors 19c, 19e, and 19m are provided in the sheet 11d.

Moreover, the connecting conductor patterns 15a, 15b, and 15c and the via-hole conductors 19d, 19g, 19h, and 19i are provided in the sheet 11e. The conductor patterns 16a and 17a and the via-hole conductors 19g, 19i, 19j, and 19k are provided in the sheet 11f. The conductor patterns 16b and 17b and the via-hole conductors 19g, 19i, 19j, and 19k are provided in the sheet 11g. The conductor patterns 16c and 17c and the via-hole conductors 19g, 19i, 19j, and 19k are provided in the sheet 11h. Moreover, the conductor patterns 16d and 17d are provided in the sheet 11i.

When the aforementioned sheets 11a to 11i are laminated together, the conductor patterns 16a to 16d are connected together via the via-hole conductor 19j, so that the inductance element L1 is provided, and the conductor patterns 17a to 17d are connected together via the via-hole conductor 19k, so that the inductance element L2 is provided. The capacitance element C1 is defined by the electrodes 12a and 13a, and the capacitance element C2 is defined by the electrodes 13a and 14a.

One end of the inductance element L1 is connected to the capacitor electrode 13a via the via-hole conductor 19g, the connecting conductor pattern 15c, and the via-hole conductor 19c, and the other end is connected to the power supply terminal 6 via the via-hole conductor 19d, the connecting conductor pattern 15b, and the via-hole conductors 19m and 19b. The capacitor electrode 12a is connected to the power supply terminal 5 via the via-hole conductor 19a.

On the other hand, one end of the inductance element L2 is connected to the capacitor electrode 14a via the via-hole conductor 19i, the connecting conductor pattern 15a, and the via-hole conductor 19e, and the other end is connected to the power supply terminal 6 via the via-hole conductor 19h, the connecting conductor pattern 15b, and the via-hole conductors 19m and 19b. The other ends of the inductance elements L1 and L2 are connected via the connecting conductor pattern 15b.

In the antenna 1B having the aforementioned structure, the LC series resonant circuits, which respectively include the inductance elements L1 and L2 magnetically coupled together, resonate, and the inductance elements L1 and L2 function as a radiating element. Moreover, the inductance elements L1 and L2 are coupled together via the capacitance element C2, so that the LC series resonant circuits function as a matching circuit that matches the impedance (approximately 50Ω) of devices connected to the power supply terminals 5 and 6 and the impedance (approximately 377Ω) of space.

As the result of a simulation performed by the inventor using the equivalent circuit shown in FIG. 7, in the antenna 1B, reflection characteristics shown in FIG. 9 were obtained.

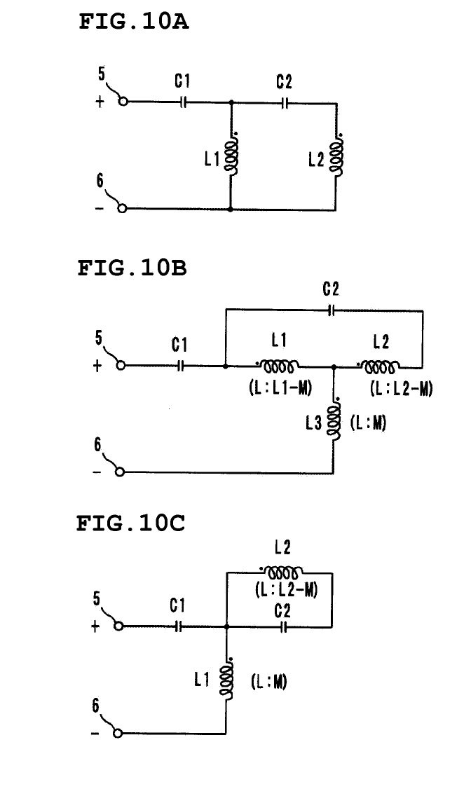

The reason why reflection characteristics can be obtained in a broad band in the antenna 1B according to the second preferred embodiment will now be described in detail. Referring to FIG. 10A shows the circuit configuration of the antenna 1B. FIG. 10B shows a circuit configuration in which a π circuit part that includes the inductance element L1, the capacitance element C2, and the inductance element L2 in Part (A) is transformed into a T circuit. In FIG. 10B, when L1<L2, L1−LM≦0 because of the value of the mutual inductance M. In this case, when L1−M=0, the circuit shown in FIG. 10B can be transformed into a circuit shown in FIG. 10C. When L1−M<0, the capacitance C2 in the circuit shown in FIG. 10C is C2′. The circuit shown in FIG. 10C obtained by the transformation of the circuit includes a series resonant circuit that includes the capacitance C1 and the mutual inductance M and a parallel resonant circuit that includes the capacitance C2 and the inductance L2−M. Thus, a broad band can be achieved by expanding the band width by increasing the spacing between resonant frequencies of the individual resonant circuits. The band width is appropriately set via the individual resonant frequencies, i.e., the values of L1, L2, and M.

### Third Preferred Embodiment

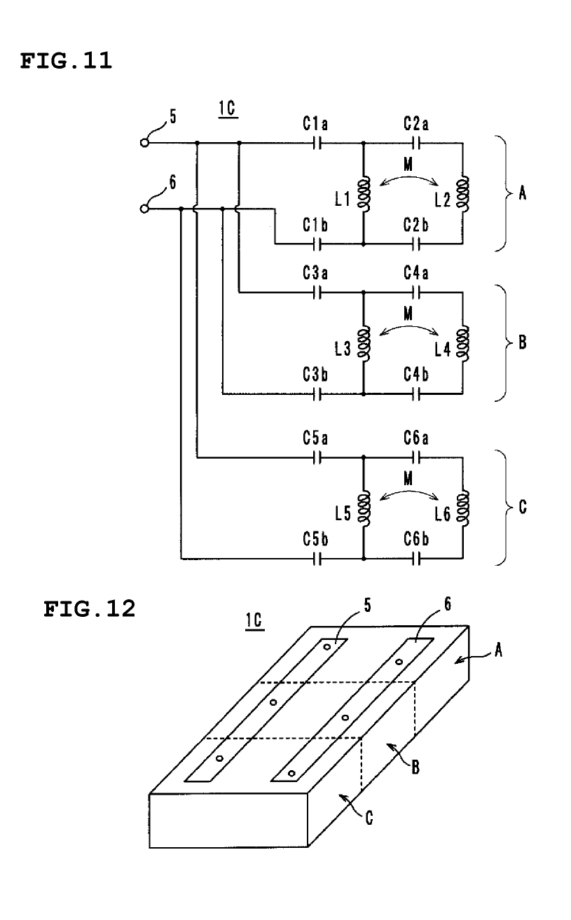

An antenna 1C according to a third preferred embodiment includes blocks A, B, and C, each of which includes two LC series resonant circuits, as shown as an equivalent circuit in FIG. 11. The LC series resonant circuits included in each of the blocks A, B, and C have the same circuit configuration as the antenna 1A according to the first preferred embodiment, and the detailed description is omitted.

In the antenna 1C, laminates, each shown in FIG. 2, are disposed in parallel as the blocks A, B, and C, and the LC series resonant circuits in each of the blocks A, B, and C are connected to the common power supply terminals 5 and 6, as shown in FIG. 12.

In the antenna 1C having the aforementioned structure, the LC series resonant circuits, which respectively include the inductance elements L1 and L2, inductance elements L3 and L4, and inductance elements L5 and L6, magnetically coupled together, resonate and function as a radiating element. Moreover, the inductance elements are coupled together via the capacitance elements, so that the LC series resonant circuits function as a matching circuit that matches the impedance (approximately 50Ω) of devices connected to the power supply terminals 5 and 6 and the impedance (approximately 377Ω) of space.

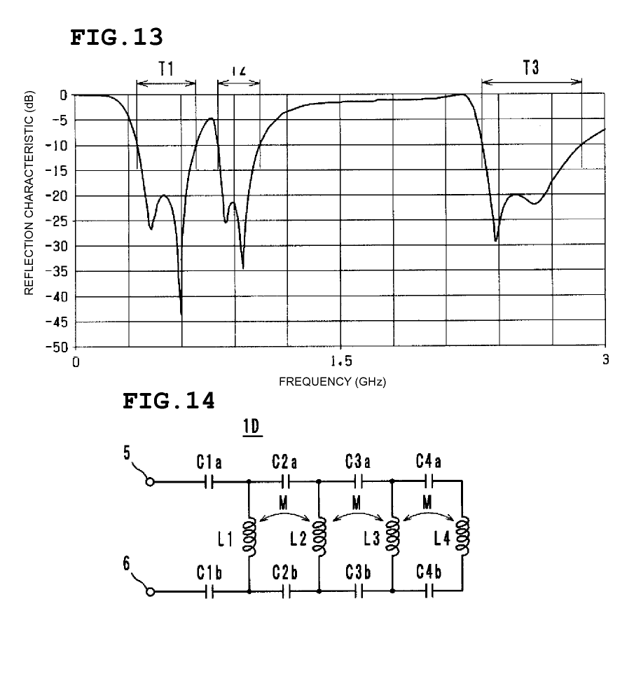

That is to say, the antenna 1C according to the third preferred embodiment is the same as three pieces of the antenna 1A according to the first preferred embodiment, connected in parallel. As the result of a simulation performed by the inventor using the equivalent circuit shown in FIG. 11, reflection characteristics of about −10 dB or less were obtained in three frequency bands T1, T2, and T3, as shown in FIG. 13. The bands T1, T2, and T3 correspond to UHF television, GSM, and a wireless LAN, respectively. The other operations and effects in the third preferred embodiment are similar to those in the aforementioned first preferred embodiment.

### Fourth Preferred Embodiment

An antenna 1D according to a fourth preferred embodiment includes the inductance elements L1, L2, L3, and L4, which have different inductance values and are magnetically coupled together in phase (indicated by the mutual inductance M), as shown as an equivalent circuit in FIG. 14. The inductance element L1 is connected to the power supply terminals 5 and 6 via the capacitance elements C1a and C1b, and is connected in parallel with the inductance element L2 via the capacitance elements C2a and C2b, the inductance element L3 via capacitance elements C3a and C3b, and the inductance element L4 via the capacitance elements C4a and C4b. That is to say, this resonant circuit includes an LC series resonant circuit that includes the inductance element L1 and the capacitance elements C1a and C1b, an LC series resonant circuit that includes the inductance element L2 and the capacitance elements C2a and C2b, an LC series resonant circuit that includes the inductance element L3 and the capacitance elements C3a and C3b, and an LC series resonant circuit that includes the inductance element L4 and the capacitance elements C4a and C4b.

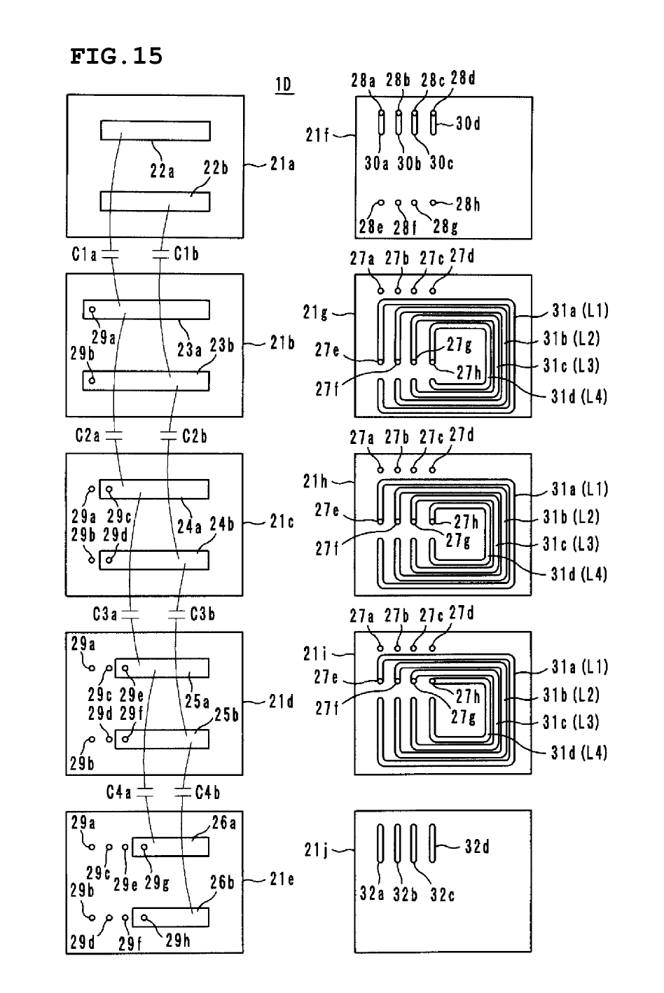

The antenna 1D having the aforementioned circuit configuration is formed as a laminate shown as an example in FIG. 15, and is composed of ceramic sheets 21a to 21j of dielectric material that are laminated, pressure bonded, and fired together. That is to say, capacitor electrodes 22a and 22b that also function as the power supply terminals 5 and 6 are provided in the sheet 21a, capacitor electrodes 23a and 23b and via-hole conductors 29a and 29b are provided in the sheet 21b, capacitor electrodes 24a and 24b and via-hole conductors 29a to 29d are provided in the sheet 21c. Capacitor electrodes 25a and 25b, the via-hole conductors 29a to 29f, and via-hole conductors 29e and 29f are provided in the sheet 21d, and capacitor electrodes 26a and 26b and via-hole conductors 29a to 29h are provided in the sheet 21e.

Moreover, connecting conductor patterns 30a to 30d and via-hole conductors 28a to 28h are provided in the sheet 21f. Conductor patterns 31a to 31d and via-hole conductors 27a to 27h are provided in the sheet 21g. The conductor patterns 31a to 31d and the via-hole conductors 27a to 27h are provided in the sheet 21h. The conductor patterns 31a to 31d and the via-hole conductors 27a to 27h are provided in the sheet 21i. Moreover, connecting conductor patterns 32a to 32d are provided in the sheet 21j.

When the aforementioned sheets 21a to 21j are laminated together, the individual conductor patterns 31a to 31d are connected via the via-hole conductors 27e to 27h, respectively, so that the inductance elements L1 to L4 are formed. One end of the inductance element L1 is connected to the capacitor electrode 23a via the via-hole conductor 27e, the connecting conductor pattern 32a, the via-hole conductors 27a and 28a, the connecting conductor pattern 30a and the via-hole conductor 29a. The other end of the inductance element L1 is connected to the capacitor electrode 23b via the via-hole conductors 28e and 29b. One end of the inductance element L2 is connected to the capacitor electrode 24a via the via-hole conductor 27f, the connecting conductor pattern 32b, the via-hole conductors 27b and 28b, the connecting conductor pattern 30b and the via-hole conductor 29c. The other end of the inductance element L2 is connected to the capacitor electrode 24b via the via-hole conductors 28f and 29d.

Moreover, one end of the inductance element L3 is connected to the capacitor electrode 25a via the via-hole conductor 27g, the connecting conductor pattern 32c, the via-hole conductors 27c and 28c, the connecting conductor pattern 30c and the via-hole conductor 29e. The other end of the inductance element L3 is connected to the capacitor electrode 25b via the via-hole conductors 28g and 29f. One end of the inductance element L4 is connected to the capacitor electrode 26a via the via-hole conductor 27h, the connecting conductor pattern 32d, the via-hole conductors 27d and 28d, the connecting conductor pattern 30d and the via-hole conductor 29g. The other end of the inductance element L4 is connected to the capacitor electrode 26b via the via-hole conductors 28h and 29h.

The capacitance element C1a is defined by the electrodes 22a and 23a, and the capacitance element C1b is defined by the electrodes 22b and 23b. The capacitance element C2a is defined by the electrodes 23a and 24a, and the capacitance element C2b is defined by the electrodes 23b and 24b. Moreover, the capacitance element C3a is defined by the electrodes 24a and 25a, and the capacitance element C3b is defined by the electrodes 24b and 25b. The capacitance element C4a is defined by the electrodes 25a and 26a, and the capacitance element C4b is defined by the electrodes 25b and 26b.

In the antenna 1D having the aforementioned structure, the LC series resonant circuits, which respectively include the inductance elements L1 to L4 magnetically coupled together, resonate, and the inductance elements L1 to L4 function as a radiating element. Moreover, the inductance elements L1 to L4 are coupled together via the capacitance elements C2a, C2b, C3a, C3b, C4a, and C4b, so that the LC series resonant circuits function as a matching circuit that matches the impedance (generally 50Ω) of devices connected to the power supply terminals 5 and 6 and the impedance (377Ω) of space.

The coupling coefficient k1 between the adjacent inductance elements L1 and L2, the coupling coefficient k2 between the inductance elements L2 and L3, and the coupling coefficient k3 between the inductance elements L3 and L4 are expressed by k1²=M²(L1×L2), k2²=M²(L2×L3), and k3²=M²(L3×L4), respectively, and are preferably equal to or more than 0.1. In the fourth preferred embodiment, k1, k2, and k3 are about 0.7624, 0.5750, and 0.6627, respectively. The inductance values of the inductance elements L1 to L4 and the values of the coupling coefficients k1, k2, and k3 are set so that a desired band width is obtained.

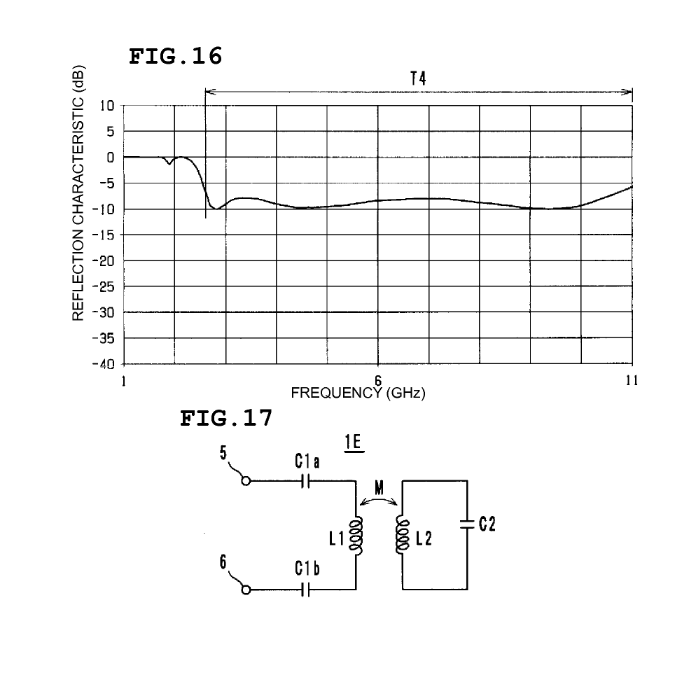

As a result of a simulation performed by the inventor using the equivalent circuit shown in FIG. 14, in the antenna 1D, reflection characteristics of about −6 dB or less were obtained in an extremely broad frequency band T4, as shown in FIG. 16. The other operations and effects in the fourth preferred embodiment are similar to those in the aforementioned first preferred embodiment.

### Fifth Preferred Embodiment

An antenna 1E according to a fifth preferred embodiment includes the inductance elements L1 and L2, which have different inductance values and are magnetically coupled together in phase (indicated by the mutual inductance M), as shown as an equivalent circuit in FIG. 17. The inductance element L1 is connected to the power supply terminals 5 and 6 via the capacitance elements C1a and C1b, and the inductance element L1 and the capacitance elements C1a and C1b define an LC series resonant circuit. Moreover, the inductance element L2 is connected in series with the capacitance element C2 to define an LC series resonant circuit.

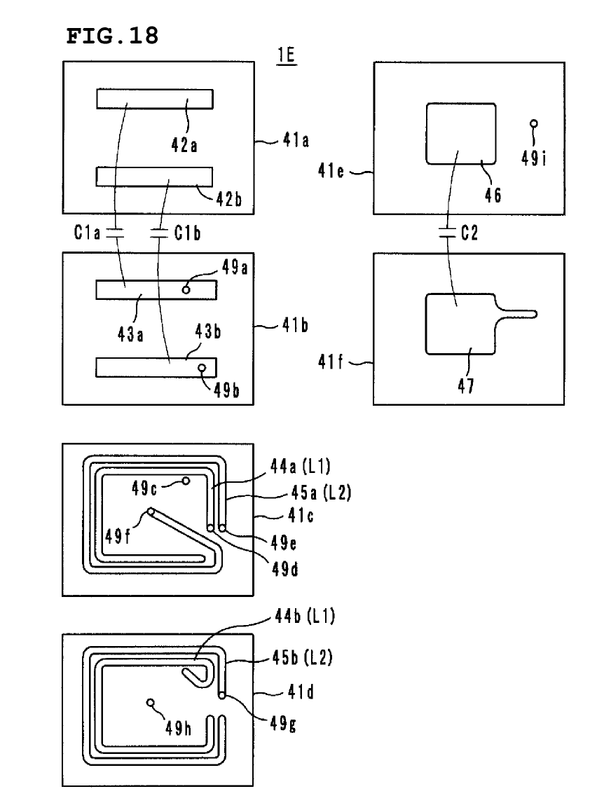

The antenna 1E having the aforementioned circuit configuration is formed as a laminate shown as an example in FIG. 18, and is composed of ceramic sheets 41a to 41f of dielectric material that are laminated, pressure bonded, and fired together. That is to say, capacitor electrodes 42a and 42b that also function as the power supply terminals 5 and 6 are provided in the sheet 41a, and capacitor electrodes 43a and 43b and via-hole conductors 49a and 49b are provided in the sheet 41b.

Moreover, conductor patterns 44a and 45a and via-hole conductors 49c, 49d, 49e, and 49f are provided in the sheet 41c. Conductor patterns 44b and 45b and via-hole conductors 49g and 49h are provided in the sheet 41d. A capacitor electrode 46 and a via-hole conductor 49i are provided in the sheet 41e. Moreover, a capacitor electrode 47 is provided in the sheet 41f.

When the aforementioned sheets 41a to 41f are laminated together, the conductor patterns 44a and 44b are connected together via the via-hole conductor 49d, so that the inductance element L1 is provided, and the conductor patterns 45a and 45b are connected together via the via-hole conductor 49e, so that the inductance element L2 is provided. The capacitance element C1a is provided of the electrodes 42a and 43a, and the capacitance element C1b is provided of the electrodes 42b and 43b. Moreover, the capacitance element C2 is provided of the electrodes 46 and 47.

One end of the inductance element L1 is connected to the capacitor electrode 43a via the via-hole conductors 49c and 49a, and the other end is connected to the capacitor electrode 43b via the via-hole conductor 49b. One end of the inductance element L2 is connected to the capacitor electrode 46 via the via-hole conductors 49f and 49h, and the other end is connected to the capacitor electrode 47 via the via-hole conductors 49g and 49i.

In the antenna 1E having the aforementioned structure, the LC series resonant circuits, which respectively include the inductance elements L1 and L2 magnetically coupled together, resonate, and the inductance elements L1 and L2 function as a radiating element. Moreover, the inductance elements L1 and L2 are magnetically coupled together, so that the LC series resonant circuits function as a matching circuit that matches the impedance (about 50Ω) of devices connected to the power supply terminals 5 and 6 and the impedance (about 377Ω) of space.

The operations and effects in the antenna 1E according to the fifth preferred embodiment are similar to those in the antenna 1A according to the aforementioned first preferred embodiment.

### Sixth Preferred Embodiment

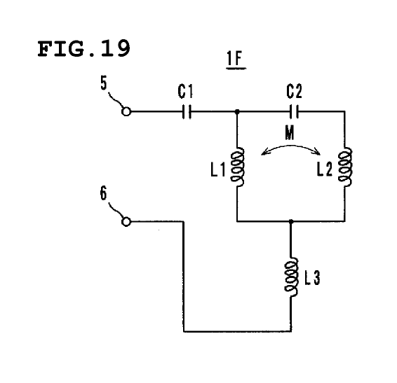

An antenna 1F according to a sixth preferred embodiment includes the inductance elements L1 and L2, which have different inductance values and are magnetically coupled together in phase (indicated by the mutual inductance M), as shown as an equivalent circuit in FIG. 19. The inductance element L1 is connected to the power supply terminal 5 via the capacitance element C1, and the inductance element L1 and the capacitance element C1 define an LC series resonant circuit. Moreover, the inductance element L2 is connected in series with the capacitance element C2 to define an LC series resonant circuit. Moreover, one end of the inductance element L3 is connected to the power supply terminal 6, and the other end is connected to the inductance elements L1 and L2. The inductance values of the inductance elements L1, L2, and L3 and the degree (the mutual inductance M) of the magnetic coupling between the inductance elements L1 and L2 are set so that a desired band width is obtained.

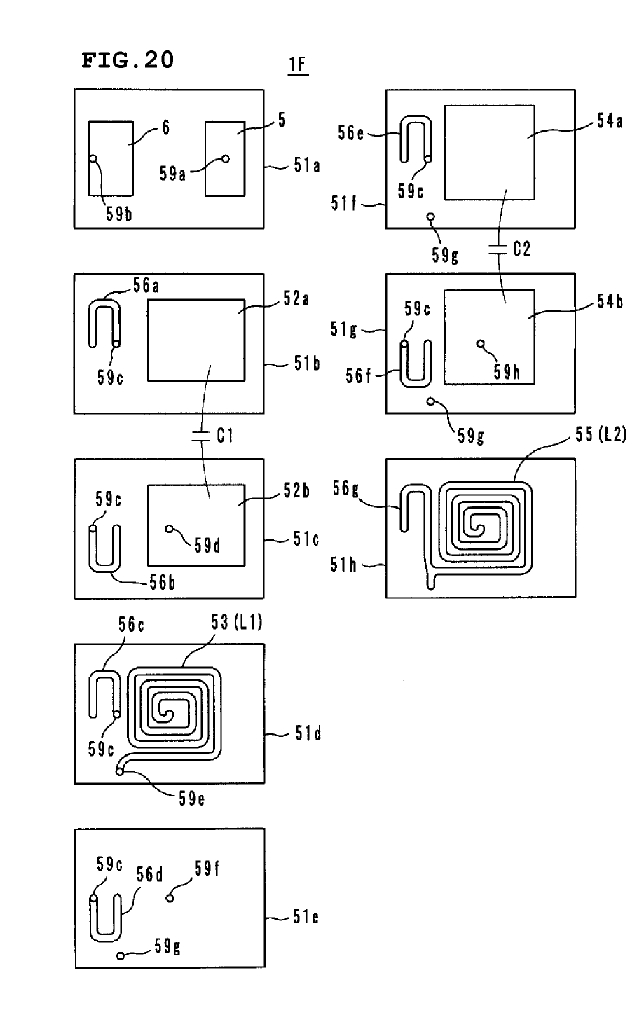

The antenna 1F having the aforementioned circuit configuration is formed as a laminate shown as an example in FIG. 20, and includes ceramic sheets 51a to 51h of dielectric material that are laminated, pressure bonded, and fired together. That is to say, the power supply terminals 5 and 6 and via-hole conductors 59a and 59b are provided in the sheet 51a. A capacitor electrode 52a, a conductor pattern 56a, and a via-hole conductor 59c are provided at the sheet 51b. A capacitor electrode 52b, a conductor pattern 56b, the via-hole conductor 59c, and a via-hole conductor 59d are provided at the sheet 51c.

Moreover, conductor patterns 53 and 56c, the via-hole conductor 59c, and a via-hole conductor 59e are provided in the sheet 51d. A conductor pattern 56d, the via-hole conductor 59c, and via-hole conductors 59f and 59g are provided in the sheet 51e. A capacitor electrode 54a, a conductor pattern 56e, and the via-hole conductors 59c and 59g are provided in the sheet 51f. A capacitor electrode 54b, a conductor pattern 56f, the via-hole conductors 59c, 59g and 59h are provided at the sheet 51g. Moreover, a conductor pattern 55 is provided on the sheet 51h, and another end of the conductor pattern 55 is provided as a conductor 56g.

When the aforementioned sheets 51a to 51h are laminated together, the conductor pattern 53 is provided as the inductance element L1, and the conductor pattern 55 is provided as the inductance element L2. Moreover, the conductor patterns 56a to 56g are connected together via the via-hole conductor 59c to define the inductance element L3. Moreover, the capacitance element C1 is defined by the capacitor electrodes 52a and 52b, and the capacitance element C2 is defined the capacitor electrodes 54a and 54b.

One end of the inductance element L1 is connected to the capacitor electrode 52b via the via-hole conductor 59d, and the other end is connected to another end of the inductance element L2 via the via-hole conductors 59e and 59g. One end of the inductance element L2 is connected to the capacitor electrode 54b via the via-hole conductor 59h, and the other end is connected to the other end of the inductance element L1 via the via-hole conductors 59g and 59e, as described above, and is connected to one end (the conductor pattern 56g) of the inductance element L3. The other end of the inductance element L3 is connected to the power supply terminal 6 via the via-hole conductor 59b. Moreover, the capacitor electrode 52a is connected to the power supply terminal 5 via the via-hole conductor 59a.

In the antenna 1F having the aforementioned structure, the LC series resonant circuits, which respectively include the inductance elements L1 and L2 magnetically coupled together, resonate, and the inductance elements L1 and L2 function as a radiating element. Moreover, the inductance elements L1 and L2 are magnetically coupled together, so that the LC series resonant circuits function as a matching circuit that matches the impedance (about 50Ω) of devices connected to the power supply terminals 5 and 6 and the impedance (about 377Ω) of space.

In the antenna 1F, even when the magnetic coupling between the inductance elements L1 and L2 is weak, since the elements L1 and L2 are directly connected to each other, a broad band is ensured. Moreover, since the other ends of the inductance elements L1 and L2 are connected to the power supply terminal 6 via the inductance element L3, the coupling coefficient k between the inductance elements L1 and L2 can be increased. Moreover, the inductance element L3 is added, so that a broad band is achieved even when the coupling coefficient between the inductance elements L1 and L2 is relatively small. The other operations and effects in the antenna 1F according to the sixth preferred embodiment are similar to those in the antenna 1A according to the aforementioned first preferred embodiment.

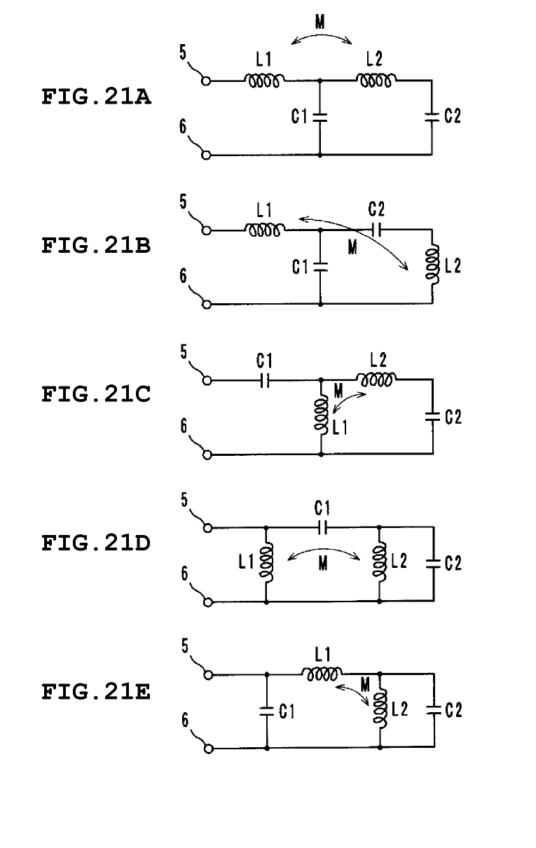

Other than the aforementioned first to sixth preferred embodiments, various types of resonant circuits that define an antenna, for example, shown as equivalent circuits in FIG. 21A to 21E, can be used, and broad-band characteristics can be achieved with small circuits.

In FIG. 21A, the inductance element L1 and the capacitance element C1 define an LC series resonant circuit, and the inductance element L2 and the capacitance element C2 define an LC series resonant circuit. The inductance elements L1 and L2 are directly connected to each other, one end of the inductance element L1 is connected to the power supply terminal 5, and the capacitance elements C1 and C2 are connected to the power supply terminal 6.

In FIG. 21B, the inductance element L1 and the capacitance element C1 define an LC series resonant circuit, and the inductance element L2 and the capacitance element C2 define an LC series resonant circuit. One end of the inductance element L1 is connected to the power supply terminal 5, the capacitance element C2 is connected between the inductance elements L1 and L2, and the capacitance element C1 and another end of the inductance element L2 are connected to the power supply terminal 6.

In FIG. 21C, the inductance element L1 and the capacitance element C1 define an LC series resonant circuit, and the inductance element L2 and the capacitance element C2 define an LC series resonant circuit. The inductance elements L1 and L2 are directly connected to each other, the capacitance element C1 is connected to the power supply terminal 5, and the capacitance element C2 and another end of the inductance element L1 are connected to the power supply terminal 6.

In FIG. 21D, the inductance element L1 and the capacitance element C1 define an LC series resonant circuit, and the inductance element L2 and the capacitance element C2 define an LC series resonant circuit. One end of the inductance element L1 is connected to one end of the inductance element L2 via the capacitance element C1, and the other ends of the inductance elements L1 and L2 are directly connected to each other. The one end of the inductance element L1 is connected to the power supply terminal 5, and the other ends of the inductance elements L1 and L2 are connected to the power supply terminal 6.

In FIG. 21E, the inductance element L1 and the capacitance element C1 define an LC series resonant circuit, and the inductance element L2 and the capacitance element C2 define an LC series resonant circuit. The inductance elements L1 and L2 are directly connected to each other, a node between one end of the inductance element L1 and the capacitance element C1 is connected to the power supply terminal 5, and a node between another end of the inductance element L2 and the capacitance element C1 is connected to the power supply terminal 6.

### Seventh Preferred Embodiment

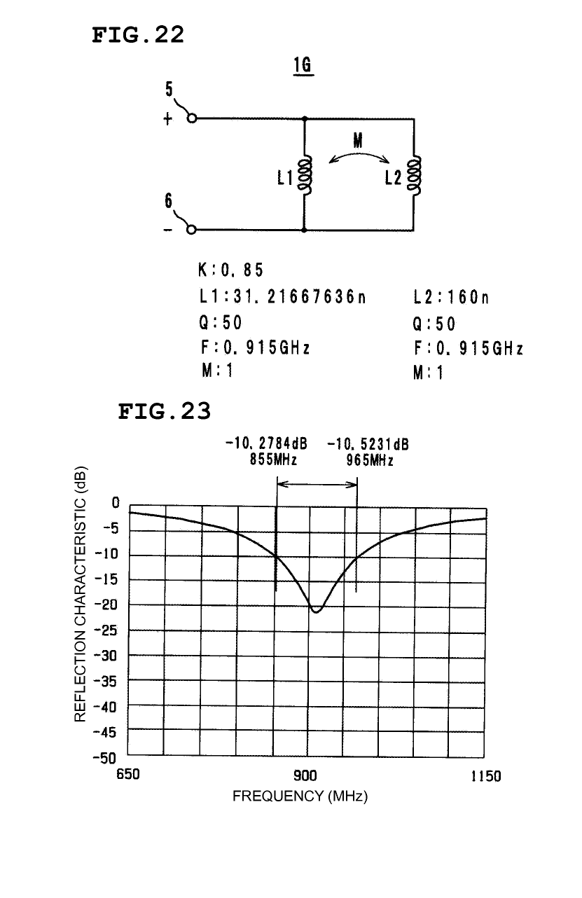

An antenna 1G according to a seventh preferred embodiment includes the inductance elements L1 and L2, which have different inductance values and are magnetically coupled together in phase (indicated by the mutual inductance M), as shown as an equivalent circuit in FIG. 22. The inductance elements L1 and L2 are connected in parallel with the power supply terminals 5 and 6.

In the antenna 1G having the aforementioned circuit configuration, the inductance elements L1 and L2 have different inductance values and are magnetically coupled together in phase. Then, the mutual inductance M (=L1-L2) is produced by the magnetic coupling between the inductance elements L1 and L2. According to a simulation performed by the inventor, the antenna 1G was found to function as a radiating element having reflection characteristics in a broad band, as shown in FIG. 23.

When a matching circuit is defined by only the two inductance elements L1 and L2, although the impedance or reactance of devices connected to the power supply terminals 5 and 6 is restricted, reflection characteristics in a broad band are obtained, as shown in FIG. 23.

### Eighth Preferred Embodiment

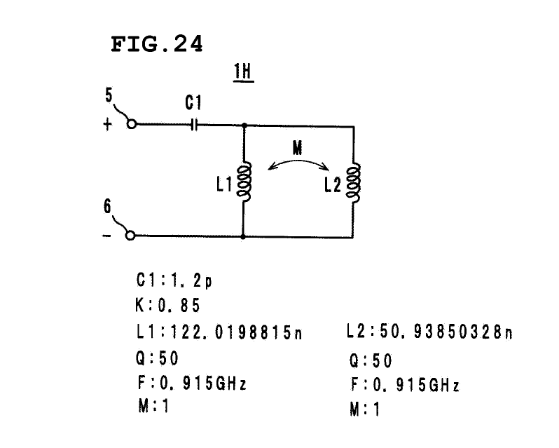

An antenna 1H according to an eighth preferred embodiment includes the inductance elements L1 and L2 shown in the aforementioned seventh preferred embodiment and the capacitance element C1 connected between one end of the inductance element L1 and the power supply terminal 5, as shown as an equivalent circuit in FIG. 24.

In the antenna 1H having the aforementioned circuit configuration, the mutual inductance M is produced by the magnetic coupling between the inductance elements L1 and L2, which have different inductance values. According to a simulation performed by the inventor, reflection characteristics in a broad band shown in FIG. 25 are obtained.

### Ninth Preferred Embodiment

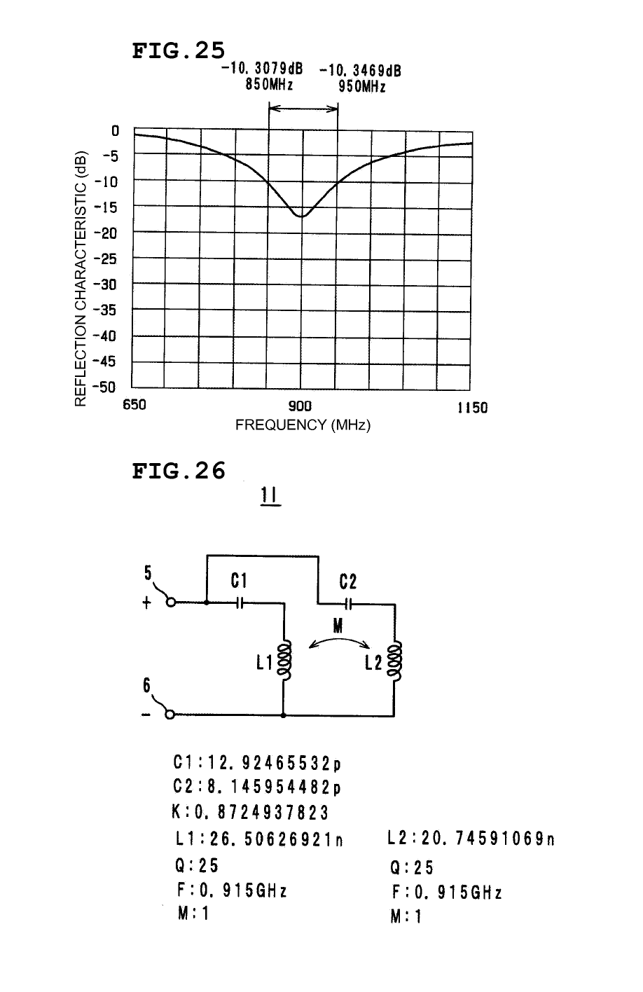

An antenna 1I according to a ninth preferred embodiment includes the inductance elements L1 and L2 shown in the aforementioned seventh preferred embodiment and the capacitance elements Cl and C2 respectively connected between the power supply terminal 5 and ends of the inductance elements L1 and L2, as shown as an equivalent circuit in FIG. 26.

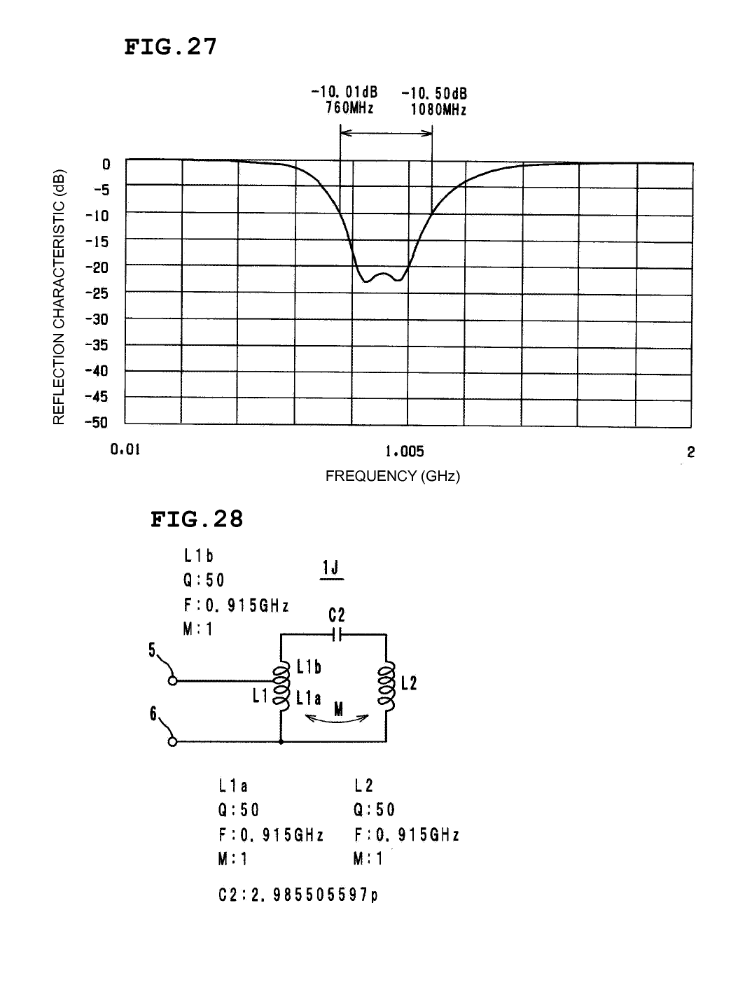

In the antenna 1I having the aforementioned circuit configuration, the mutual inductance M is produced by the magnetic coupling between the inductance elements L1 and L2, which have different inductance values. According to a simulation performed by the inventor, reflection characteristics in a broad band shown in FIG. 27 are obtained.

### Tenth Preferred Embodiment

In an antenna 1J according to a tenth preferred embodiment shown as an equivalent circuit in FIG. 28, what is called a mid tap is provided in the inductance element L1 shown in the aforementioned second preferred embodiment, the power supply terminal 5 is connected to the mid tap, and the capacitance element C1 is omitted.

Although the operations and effects are substantially the same as those in the second preferred embodiment, the impedance of space and the impedance of devices connected between the power supply terminals 5 and 6 can be matched without a decrease in the electromagnetic field energy by providing a mid tap so as to suit the impedance between the power supply terminals 5 and 6. In this case, the inductance element L1 is divided into inductances L1a and L1b.

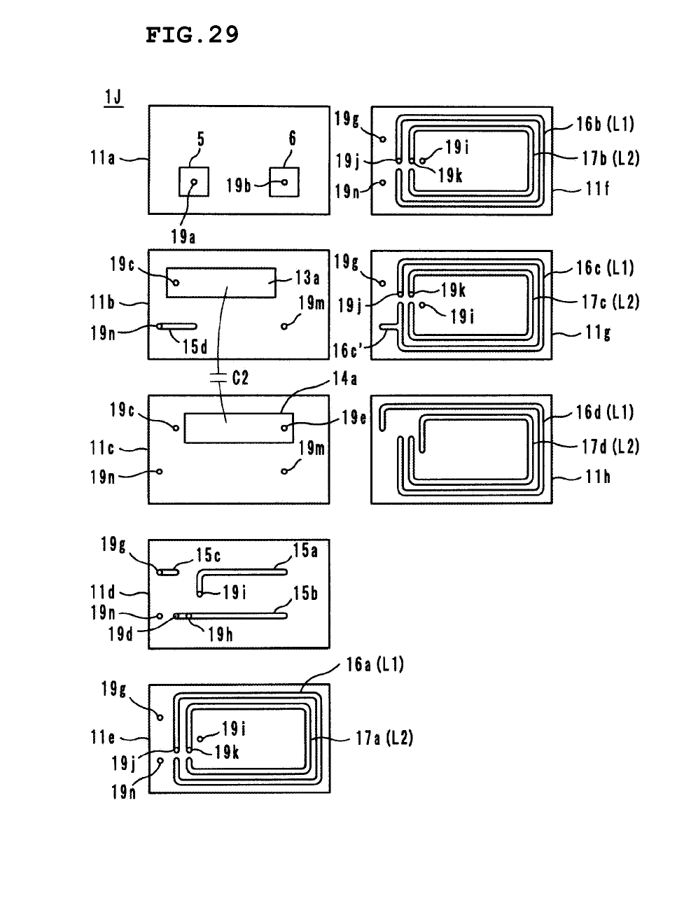

The antenna 1J having the aforementioned circuit configuration is formed as a laminate shown as an example in FIG. 29, and includes the ceramic sheets 11a to 11h of dielectric material that are laminated, pressure bonded, and fired together. That is to say, the power supply terminals 5 and 6 and the via-hole conductors 19a and 19b are provided in the sheet 11a, the capacitor electrode 13a, a connecting conductor pattern 15d, the via-hole conductors 19c, 19m and 19n are provided at the sheet 11b, and the capacitor electrode 14a and the via-hole conductors 19c, 19e, 19m, and 19n are provided at the sheet 11c.

Moreover, the connecting conductor patterns 15a, 15b, and 15c and the via-hole conductors 19d, 19g, 19h, 19i, and 19n are provided at the sheet 11d. The conductor patterns 16a and 17a and the via-hole conductors 19g, 19i, 19j, 19k, and 19n are provided at the sheet 11e. The conductor patterns 16b and 17b and the via-hole conductors 19g, 19i, 19j, 19k, and 19n are provided at the sheet 11f. The conductor patterns 16c and 17c and the via-hole conductors 19g, 19i, 19j, and 19k are provided at the sheet 11g. Moreover, the conductor patterns 16d and 17d are provided at the sheet 11h.

When the aforementioned sheets 11a to 11h are laminated together, the conductor patterns 16a to 16d are connected together via the via-hole conductor 19j, so that the inductance element L1 is provided. A branch 16c′ of the conductor pattern 16c functions as a mid tap, and the branch 16c′ is connected to the power supply terminal 5 via the via-hole conductor 19n, the connecting conductor pattern 15d, and the via-hole conductor 19a. Moreover, the conductor patterns 17a to 17d are connected together via the via-hole conductor 19k, so that the inductance element L2 is provided. The capacitance element C2 is defined by the electrodes 13a and 14a.

One end of the inductance element L1 is connected to the capacitor electrode 13a via the via-hole conductor 19g, the connecting conductor pattern 15c, and the via-hole conductor 19c, and the other end is connected to the power supply terminal 6 via the via-hole conductor 19d, the connecting conductor pattern 15b, and the via-hole conductors 19m and 19b.

On the other hand, one end of the inductance element L2 is connected to the capacitor electrode 14a via the via-hole conductor 19i, the connecting conductor pattern 15a, and the via-hole conductor 19e, and the other end is connected to the power supply terminal 6 via the via-hole conductor 19h, the connecting conductor pattern 15b, and the via-hole conductors 19m and 19b. The other ends of the inductance elements L1 and L2 are connected via the connecting conductor pattern 15b.

In the antenna 1J having the aforementioned structure, the LC series resonant circuits, which respectively include the inductance elements L1 and L2 magnetically coupled together, resonate, and the inductance elements L1 and L2 function as a radiating element. Moreover, the inductance elements L1 and L2 are coupled together via the capacitance element C2, and the branch 16c′ (the mid tap) is provided, so that the LC series resonant circuits function as a matching circuit that matches the impedance (about 50Ω) of devices connected to the power supply terminals 5 and 6 and the impedance (about 377Ω) of space.

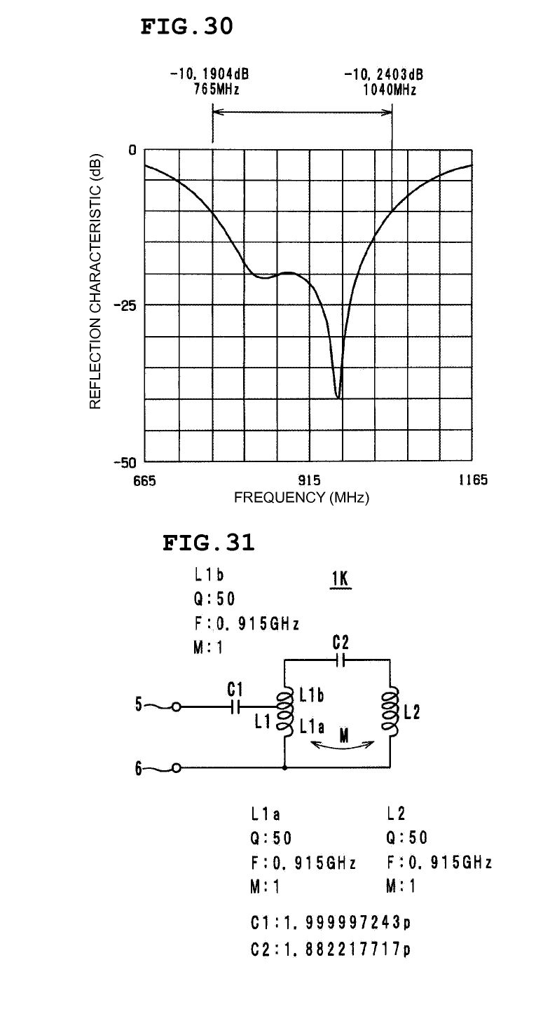

As the result of a simulation performed by the inventor using the equivalent circuit shown in FIG. 28, in the antenna 1J, reflection characteristics shown in FIG. 30 were obtained.

### Eleventh Preferred Embodiment

An antenna 1K according to an eleventh preferred embodiment is substantially the same as the antenna 1J shown in the aforementioned tenth preferred embodiment, the capacitance element C1 being added to the antenna 1J, as shown as an equivalent circuit in FIG. 31. The operations and effects are similar to those in the tenth preferred embodiment. The impedance of space and the impedance of devices connected between the power supply terminals 5 and 6 can be matched without decrease in the electromagnetic field energy by providing a mid tap so as to suit the impedance between the power supply terminals 5 and 6. Impedance matching with the power supply terminals 5 and 6 is facilitated by adding the capacitance element C1 to the tenth preferred embodiment.

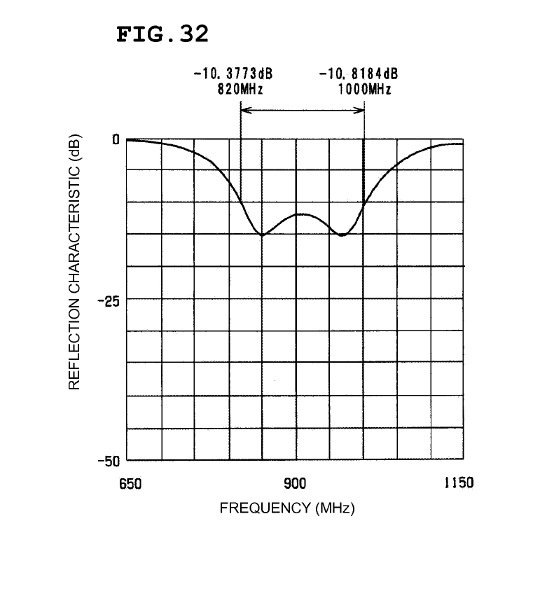

The structure of the antenna 1K having the aforementioned circuit configuration is similar to those of the laminates shown in FIGS. 8 and 29, and thus, the details are omitted. As the result of a simulation performed by the inventor using the equivalent circuit shown in FIG. 31, in the antenna 1K, reflection characteristics shown in FIG. 32 were obtained.

When impedance matching with the power supply terminals 5 and 6 is facilitated by providing a mid tap, as in the tenth and eleventh preferred embodiments, the return increases, and the band width increases accordingly. That is to say, when the degree of impedance matching changes, the band width changes. Thus, in order to obtain a desired band, the degree of impedance matching must be considered when constants of individual inductance elements are set.

Antennas according to the present invention are not limited to the aforementioned preferred embodiments, and the preferred embodiments can be modified within the scope of the present invention.

In the aforementioned preferred embodiments, an LC resonant circuit includes a lumped constant resonant circuit. Alternatively, the LC resonant circuit may include, for example, a distributed constant resonant circuit. Moreover, a laminate that includes the LC resonant circuit may be composed of insulating material, instead of dielectric material, and ceramic, resin, or other suitable materials can be used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-9. (canceled)

10. An antenna comprising:
a power supply terminal; and
at least two inductance elements having different inductance values from one another; wherein
the at least two inductance elements are arranged to radiate radio waves and define inductances of a matching circuit that matches an impedance when a power supply side is viewed from the power supply terminal and a radiation impedance of free space.

11. The antenna according to claim 10, further comprising capacitance elements, wherein the capacitance elements and the inductance elements define a plurality of resonant circuits.

12. An antenna comprising:
power supply terminals; and
a plurality of resonant circuits; wherein
the plurality of resonant circuits are arranged to radiate radio waves and define inductances of a matching circuit that matches an impedance when a power supply side is viewed from the power supply terminals and a radiation impedance of free space.

13. The antenna according to claim 12, wherein the plurality of resonant circuits include capacitance elements and inductance elements.

14. The antenna according to claim 12, wherein the plurality of resonant circuits are electrically connected to the power supply terminals directly or via one of a lumped constant capacitance and a lumped constant inductance.

15. The antenna according to claim 12, wherein a coupling coefficient between adjacent resonant circuits of the plurality of resonant circuits is at least about 0.1.

16. The antenna according to claim 13, wherein the inductance elements included in the plurality of resonant circuits include a line electrode pattern in which the inductance elements are disposed along one axis of the antenna.

17. The antenna according to claim 13, wherein the capacitance elements are electrically connected to the power supply terminals.

18. The antenna according to claim 17, wherein the capacitance elements connected to the power supply terminals are provided in a laminated substrate.

19. The antenna according to claim 12, wherein the plurality of resonant circuits are provided in a laminated substrate.

20. An antenna comprising:
first and second power supply terminals; and
a plurality of resonant circuits;
a first LC series resonant circuit including a first inductance element and first and second capacitance elements that are electrically connected to both ends of the first inductance element; and
a second LC series resonant circuit including a second inductance element and third and fourth capacitance elements that are electrically connected to both ends of the second inductance element; wherein
the first and second inductance elements are magnetically coupled together;
one end of the first inductance element is electrically connected to the first power supply terminal via the first capacitance element, and the other end is electrically connected to the second power supply terminal via the second capacitance element; and
one end of the second inductance element is electrically connected to the first power supply terminal via the third and first capacitance elements, and the other end is electrically connected to the second power supply terminal via the fourth and second capacitance elements.
